(19) United States
(12) Patent Application Publication
(10) Pub. No.: US 2026/0194952 A1
(43) Pub. Date: Jul. 9, 2026

(54) INCREASING POWER AVAILABILITY IN PARTIALLY FAILED POWER SUPPLIES

(71) Applicant: International Business Machines Corporation, Armonk, NY (US)

(72) Inventors: Luxing Wang, Cedar Park, TX (US); Francesca Felisa Andrada, Rochester, MN (US); Eric B. Swenson, Pine Island, MN (US); Justin E. HENSPETER, Georgetown, TX (US)

(21) Appl. No.: 19/009,527

(22) Filed: Jan. 3, 2025

(51) Int. Cl. G06F 1/30; H02M 1/42; H02M 1/44

(52) U.S. Cl. CPC G06F 1/30; H02M 1/4208; H02M 1/44

(57) ABSTRACT

A device may include an AC input. A device may include a DC output. A device may include power blocks. A device may include a controlling chip configured to detect a fault in one of the power blocks and isolate the power block with the fault while allowing power to flow through other power blocks.

### BACKGROUND

Aspects of the present disclosure relate to power supplies.

A power supply is designed to convert AC power into regulated DC power to operate to provide DC power to electrical systems such as computers and servers. Built for high reliability and efficiency, power supplies are engineered to handle the constant load demands of data centers and often include features like redundancy, modularity, and hot-swappable designs to ensure minimal downtime. Power supplies are typically compact but high-output devices, capable of providing substantial wattage to meet the demands of the electrical systems while managing heat and optimizing power efficiency, essential for supporting various workload demands.

### SUMMARY

Aspects of the present disclosure relate to a device, system, and method for increasing power availability in partially failed power supplies.

In some aspects, the techniques described herein relate to a device including: an alternating current (AC) input; a direct current (DC) output; power blocks; and a controlling chip configured to detect a fault in one of the power blocks and isolate the power block with the fault while allowing power to flow through other power blocks.

In some aspects, the techniques described herein relate to a system including: a memory storing program instructions; and a processor in communication with the memory, the processor being configured to execute the program instructions to perform processes including: detecting, by a controlling chip a fault in a power block of a power supply; and isolating, by the controlling chip, the power block, wherein power is allowed to flow through one or more other power blocks.

In some aspects, the techniques described herein relate to a method including: detecting, by a controlling chip, a fault in a power block of a power supply; and isolating, by the controlling chip, the power block, wherein power is allowed to flow through one or more other power blocks.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates an example computing environment, according to various embodiments of the present disclosure.

FIG. 2A depicts an example power supply with isolation capabilities, according to various embodiments of the present disclosure.

FIG. 2B depict an example power supply with one or more isolated faults, according to various embodiments of the present disclosure.

FIG. 2C depicts the example power supply where a redundant part may be isolated, according to various embodiments of the present disclosure.

FIG. 3 depicts an example method for increasing power availability in partially failed power supplies, according to various embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to increasing power availability in partially failed power supplies. While the present disclosure is not necessarily limited to such applications, various aspects of the disclosure may be appreciated through a discussion of various examples using this context. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as block 107 (e.g., code to enact method 300). In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

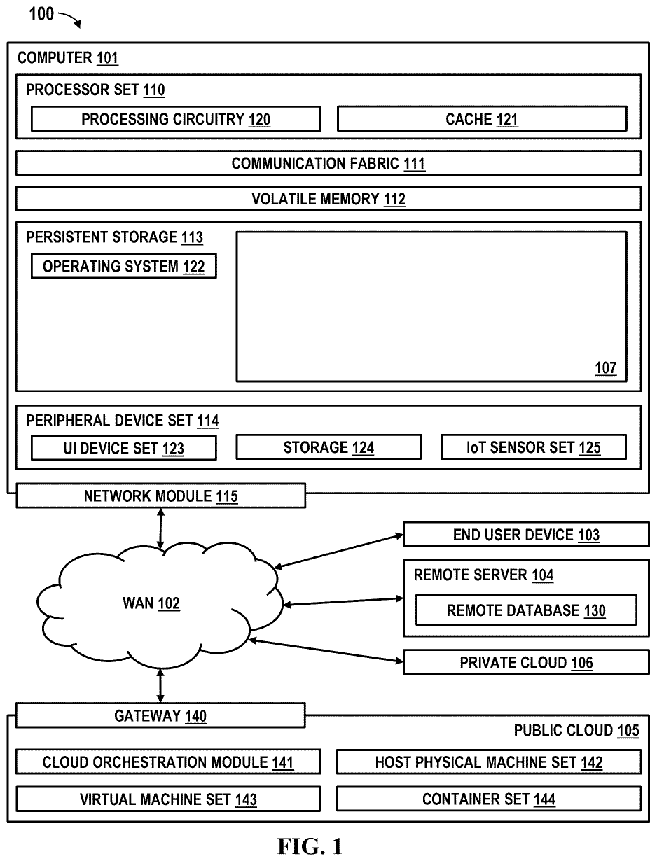

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 107 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 107 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some instances, a power supply may have four type of power blocks: Electromagnetic Interference (EMI) filter, Power Factor Correction (PFC), Direct Current Direct Current (DC-DC) converter, and ORing Field-Effect Transistors (ORing FETs). In some instances, unwanted electromagnetic energy can disrupt electronic devices. An EMI filter may be used in power supplies to reduce noise from entering or leaving the system. In some instances, a PFC is a technique or circuitry used to improve the power factor of a power supply, making it more efficient by aligning the current draw with the voltage supply. This reduces energy losses and meets regulatory requirements. In some instances, a DC-DC converter is a power supply component that converts Direct Current (DC) from one voltage level to another. For example, it can step down 24V DC to 5V DC to power smaller components. In some instances, MOSFETs are used in power supply designs to act like diodes, allowing current to flow in one direction while blocking reverse currents. ORing FETs are commonly used in systems with redundant power supplies to isolate faults and ensure reliability. In some embodiments, the ORing FETs depicted and discussed herein may be implemented using several ORing FETs in parallel. In some instances, the failure rate for a power block may depend on the type of power block. For example, EMI filters may be the least likely to fail, and DC-DC converters may be the most likely to fail.

In some instances, power supplies may use multiple sets of the power blocks to deliver the appropriate power output. However, with current technology, if one of the power blocks fails, the system may not be able to function even at a reduced capacity. Thus, there is a need to have a power supply system that can isolate faulty blocks and provide power at a reduced capacity by utilizing the power blocks that are still functioning. Therefore, a system is proposed to detect and isolate faulty blocks in a power supply.

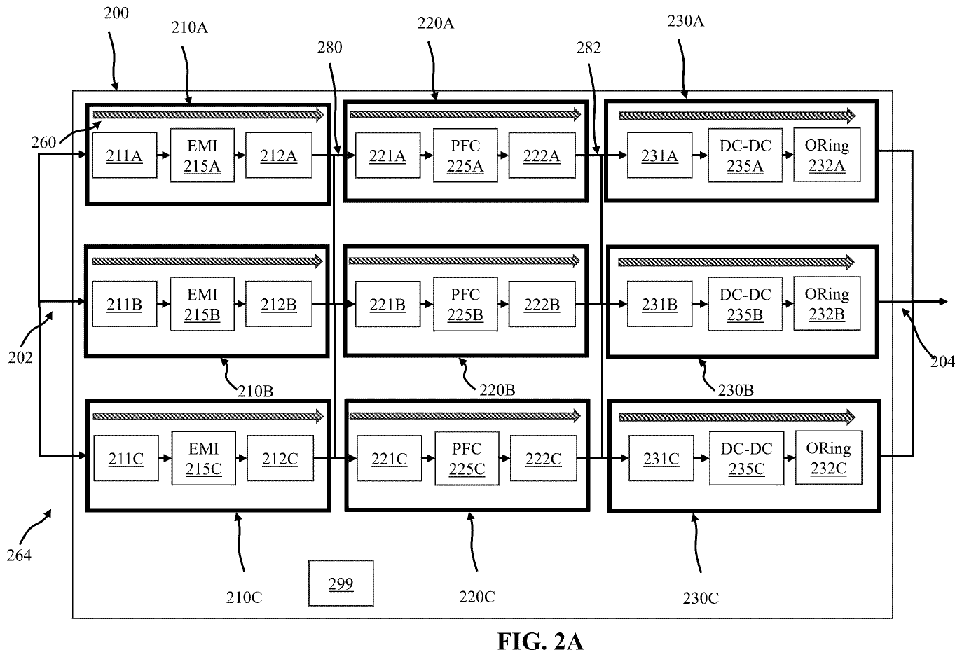

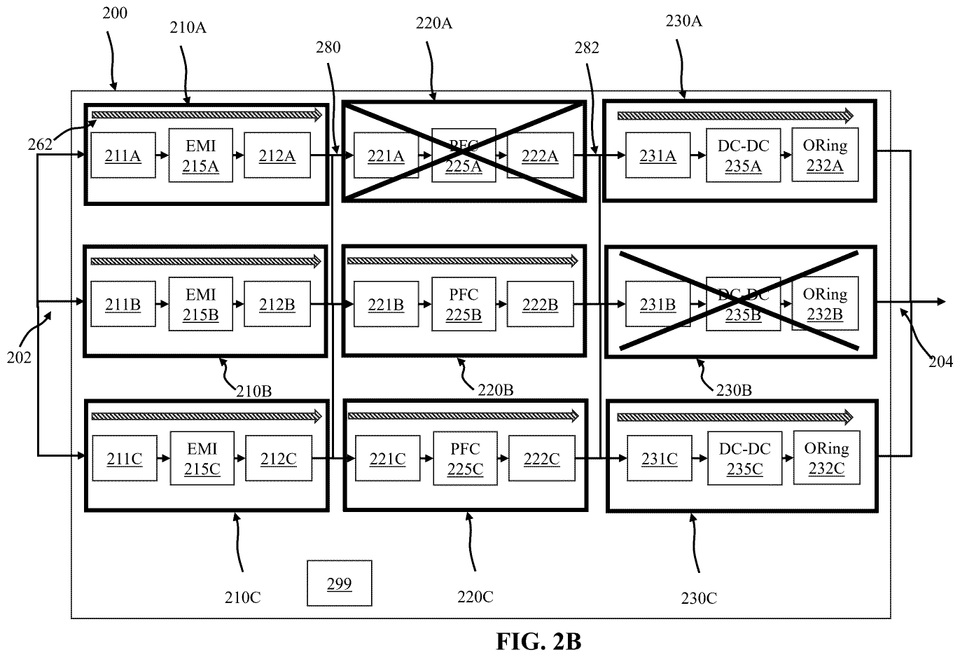

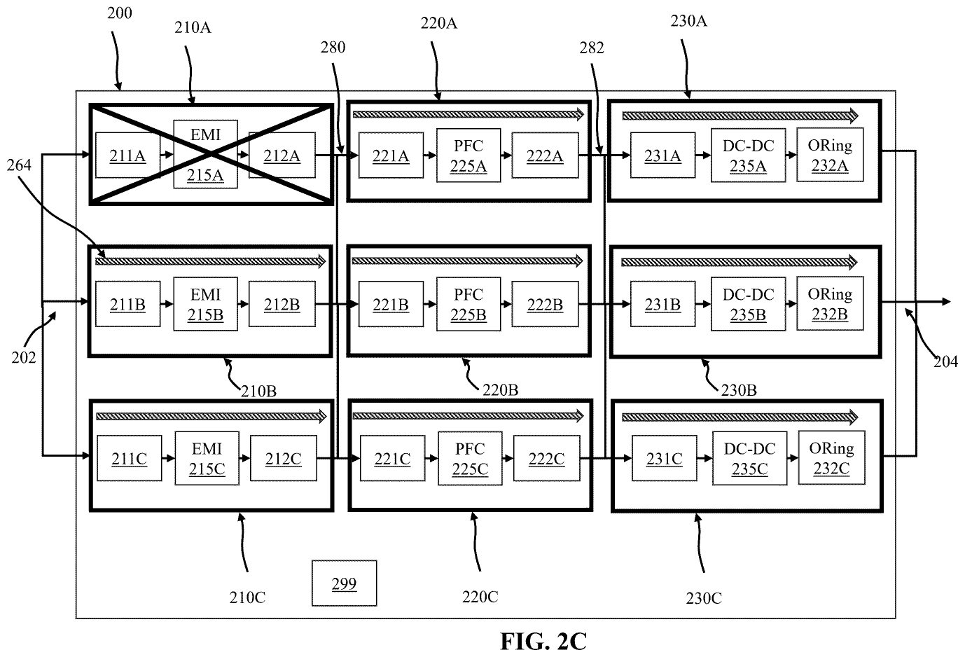

FIG. 2A depicts an example power supply 200 with isolation capabilities. In some embodiments, power supply 200 may include an AC input 202 and a DC output 204. In some embodiments, power supply 200 may include multiple (e.g., redundant) power blocks. For example, power supply 200 contains EMI filter blocks 210A-C with EMI filters 215A-C; PFC blocks 220A-C with PFC circuitry (referred to as PFCs herein) 225A-C; and DC-DC blocks 230A-C with DC-DC converters 235A-C. In some embodiments, each of the power blocks may contain one or more isolation devices 211A-C, 212A-C, 221A-C, 222A-B, and 231A-C. In some embodiments, DC-DC blocks 230A-C may include ORing FETs 232A-C instead of an isolation device. In some embodiments, the DC-DC blocks may contain a second isolation device (not depicted) and the ORings FETs may be outside of the DC-DC blocks. In some embodiments, the isolation devices are configured to block power flowing through the power block following a command from the controlling chip.

In some embodiments, devices have more or fewer power blocks than those shown. In some embodiments, the proposed power supplies may not have an equivalent number of each type of power block. For example, a power supply may have 5 EMI blocks, 15 PFC blocks, and 15 DC-DC blocks. In some embodiments, a single EMI and/or PFC stage is used to improve the overall power factor and provide a stable high-voltage DC bus (e.g., 400V DC for a PFC circuit). In some instances, the high-voltage DC output is then distributed to multiple DC-DC converters. In some instances, the DC-DC converter steps down (or adjusts) the voltage to its respective output levels (e.g., 12V, 5V, 3.3V, etc.).

In some embodiments, power paths 260 (depicted by arrows) show a depiction of how power may flow through power supply 200 with all blocks functioning. In some instances, the power paths are a depiction of a flow capacity of a power supply. For example, arrows 280 depict that all the EMI blocks 210A-C are linked to all of the PFC blocks 220A-C, and arrows 282 depict that all of the PFC blocks 220A-C are linked to all of the DC-DC blocks 230A-C. In some instances, each type of block is linked in parallel to the other types of blocks.

In some embodiments, control chip 299 (e.g., a microcontroller) may monitor and control power supply 200. Although only one control chip is depicted, a power supply may have several control chips that monitor and control the power supply. For example, each type of power block may have a control chip.

As an example, redundant blocks can be designed for half the total power capacity. In this case, it is capable of delivering full power with no failed power blocks, but half the power with a failed power block. The examples given herein are meant for explanation purposes only. The designs embodied here are not limited to 2 or 3 power blocks (systems enabled by this disclosure may be made up of 4 blocks, 5 blocks, 6 blocks, etc.). This is distinctly different from a traditional Power Supply Unit (PSU) topology.

In some embodiments, the benefit of using partial power redundant block that can be isolated is a trade-off between price and space. In some embodiments, partial power redundant blocks may also improve the availability of the power supply after a failure. In some embodiments, the benefit of the system may be in an example power supply configuration where the number of blocks represents the denominator and the number of operational blocks represents the numerator, the ratio representing the fraction of full power the power supply is able to maintain given a failure. For example, if a power supply has 3× EMI, 3× PFC and 3× DC/DC stages (each section operating in parallel and dividing the power flow evenly among the blocks) the denominator is 3, and the numerator is 3, representing a full power train providing 100% power output. If one of the blocks fails, the numerator drops to 2 (denominator stays at 3). This means the power supply can now provide ⅔ of its full power capability. The most effective configuration therefore is one where the user only loses fractional power when a single block failure occurs. This represents an increase in overall availability to the system when compared to the more standard method where the entire power supply fails with a single block failure. Using currently available technology, a server with a 2× power supply system (operating in parallel), where each is capable of 2 kW, the standard method provides an overall power of 4kW to the system. If a block within one of those power supplies fails, the whole supply fails translating to 2 kW now available to the system. Contrast this with the method and system disclosed within where only ⅓ of the capability is lost upon failure of a single block, providing a total system availability of 2 kW+1.333 kW=3.333 kW. Depending on end users'requirements a tradeoff can be made between total availability upon a power supply block failure (or more than one failure) and the cost of increasing or decreasing the denominator (e.g., the number of redundant power blocks).

FIG. 2B depicts an example power supply where PFC block 220A and DC-DC power block 230B have faults. In this example, control chip 299 may close off isolation devices 221A, 222A, and 231B. Power paths 262 (depicted by the arrows in EMI blocks 210A-C, PFC blocks 220B-C, and DC-DC blocks 235A and 235C) depicts the power flowing from EMI blocks 210A-C, to PFC blocks 220B-C, and to DC-DC blocks 230A and 230B. In some embodiments, blocks that are over the capacity of the system (e.g., one of the EMI blocks 210A-C) may be shut off, but may not significantly change the capacity of the system. For example, isolation devices 211B and 212B may also be enabled to isolate EMI block 210B even though it is not faulty. As depicted, the power paths may change as one or more blocks is isolated (e.g., power path 260 to power path 262)

In some embodiments, an isolation device may be required on both input and output of each block where the Field-Effect Transistors (ORing FETs)serve the same purpose as an isolation device). In some embodiments, both the input and output of the block must be isolated in order to not affect adjacent blocks and thus the end-to-end power train. For example, in the event of a shorted FET in one of the parallel PFC sections, the power supply may have a direct short from input to output. This will also create a short on the output of each of the adjacent outputs, which will fault the entire power train.

In the FIG. 2B example above, there are no faults in the 3 parallel EMI blocks 210A-C. Therefore, power flows equally through each (they split~evenly). For the 3 parallel PFC stages (PFC blocks 220A-C), the top PFC block 22A has a fault (and is as a result, isolated) and therefore the power flow is limited to the bottom 2× PFC blocks 220B-C (where, again, the power flow is shared~equally between the remaining 2). At the DC/DC section consisting of DC-DC blocks 230A-C, the center DC-DC block 230B is faulted and therefore the top and bottom DC/DC sections share the power flow equally). In the image, power paths 262 (depicted by arrows) show that each parallel combination contributes equally (being shared across 3 blocks in the best case but shared between 2 blocks when you have a single block faulted).

FIG. 2C depicts the example power supply where a redundant part may be isolated. In some embodiments, some blocks may be able to service more than one power line. In this example, EMI block 210A has a fault and is isolated by control chip 299. Example EMI block 210B-C each has the capacity to handle enough power for half of the power supply, thus power for PFC blocks 220A-C and DC-DC blocks 230A-C may flow through EMI block 210B (according to the power paths 264 depicted by arrows). In another example, each EMI block carries a partial load for multiple blocks. For example, EMI blocks 210B-C may have the capacity to supply the rest of the power supply fully.

In some embodiments, a power supply may have redundant blocks, and blocks may be isolated as they fail. In some embodiments, having extra or redundant blocks may improve system stability and potentially improve the power supply lifetime. In some embodiments, the redundant blocks allow the PSU to operate at full capacity or reduced capacity in terms of its rated power when any power block fails. In some embodiment, components likely to fail may have more redundant components than those that are less likely to fail. For example, any of the cases above with in a power supply that only requires 2 power blocks of each type (EMI, PFC, and DC-DC), one power block of each type would be redundant since there are 3 power blocks of each type. For example, since only two power blocks of each type are required, any one single type of power block could be faulty and the power supply would still be able to function at the full capacity required by the system.

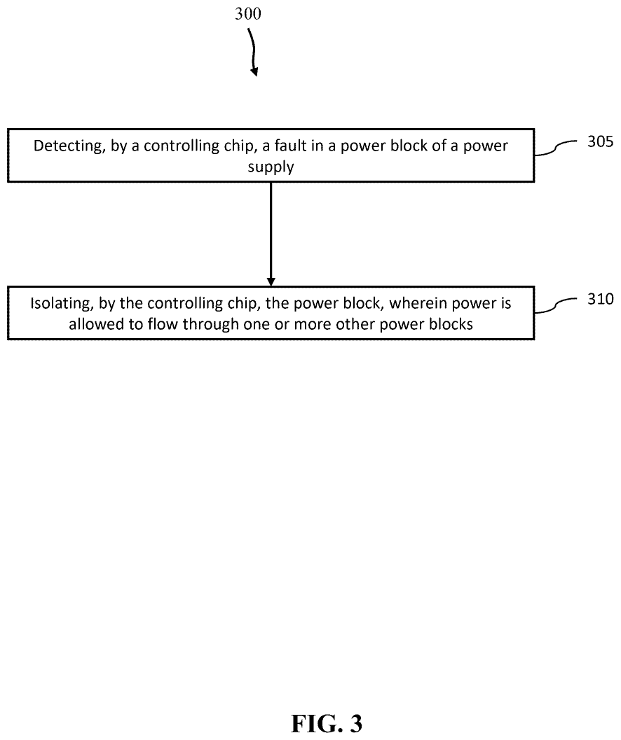

FIG. 3 depicts an example method 300 for increasing power availability in partially failed power supplies. In some embodiments, an example power supply 200 for method 300 is described above. Operations of method 300 may be enacted by one or more computing environments such as the system described in FIG. 1 above.

Method 300 begins with operation 305 of detecting, by a controlling chip, a fault in a power block. In some embodiments, a control chip (e.g., 299) may detect a fault in a power supply component by continuously monitoring key parameters and identifying anomalies that deviate from normal operation in the power blocks. In some embodiments, the control chip can measure factors such as voltage, current, temperature, frequency, and power factor to ensure the factors are within predefined thresholds. For example, overvoltage or undervoltage conditions, excessive current flow, or abnormal temperature rises may indicate potential faults. In some embodiments, the control chip may analyze patterns in voltage or current oscillations, monitor diagnostic signals, or measure circuit impedance to detect subtle changes that suggest component degradation or failure. In some embodiments, the control chip may utilize predictive analytics to identify early signs of wear or impending issues in one or more power blocks to proactively isolate a power block before the power block fails completely. In some embodiments, the control chip may have FW (firmware), and the FW may identify failed blocks.

Method 300 continues with operation 310 of isolating, the power block where power is allowed to flow through one or more other power blocks. In some embodiments, when a fault is detected, the control chip may initiate an isolation of the faulty power block by enabling one or more isolation devices in the faulty power block. For instance, in a switched-mode power supply (SMPS), the control chip might monitor the feedback loop for irregularities in output voltage caused by a failing power block and respond by isolating the failing power block.

In some embodiment, the FW may reconfigure the new limits/thresholds for the power supply. In some embodiments, FW should inform/alert the system of its new capacity (external to power supply).

In some embodiments, after isolation of one or more power blocks, the power supply may operate at a reduced capacity. In some embodiments, a single power supply may offer more power than a system needs or there may be redundant power supplies. In such systems, the proposed embodiments enable the system to continue to run with reduced power coming from the power supply.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A device comprising:
an alternating current (AC) input;
a direct current (DC) output;
power blocks; and
a controlling chip configured to detect a fault in one of the power blocks and isolate the power block with the fault while allowing power to flow through other power blocks.

2. The device of claim 1, further comprising:
isolation devices on the power blocks, wherein the isolation devices are configured to block power flowing through the power block following a command from the controlling chip.

3. The device of claim 1, wherein the power blocks may include:
electromagnetic interference (EMI) filter blocks;
power factor correction (PFC) blocks; and
DC-DC blocks.

4. The device of claim 3, further comprising:
a first isolation device before each of the EMI filter blocks and a second isolation device after each of the EMI filter blocks;
a first isolation device before each of the PFC blocks and a second isolation device after each of the PFC blocks; and
a first isolation device before each of the DC-DC blocks and a second isolation device after each of the DC-DC blocks.

5. The device of claim 4, wherein a Field-Effect Transistor (ORing FET) acts as the second isolation device for each of the DC-DC blocks.

6. The device of claim 1, further comprising:
one or more redundant blocks.

7. The device of claim 1, wherein the DC output is reduced based on the isolation.

8. A system comprising:
a memory storing program instructions; and
a processor in communication with the memory, the processor being configured to execute the program instructions to perform processes comprising:
detecting, by a controlling chip a fault in a power block of a power supply; and
isolating, by the controlling chip, the power block, wherein power is allowed to flow through one or more other power blocks.

9. The system of claim 8, wherein isolation devices on the power block are configured to block power flowing through the power block following a command from the controlling chip.

10. The system of claim 8, wherein the power block and the other power blocks may include:
electromagnetic interference (EMI) filter blocks;
Power Factor Correction (PFC) blocks; and
direct current (DC)-DC blocks.

11. The system of claim 10, wherein the blocks include:
a first isolation device before each of the EMI filter blocks and a second isolation device after each of the EMI filter blocks;
a first isolation device before each of the PFC blocks and a second isolation device after each of the PFC blocks; and
a first isolation device before each of the DC-DC blocks and a second isolation device after each of the DC-DC blocks.

12. The system of claim 11, wherein a Field-Effect Transistor (ORing FET) acts as the second isolation device for each of the DC-DC blocks.

13. The system of claim 8, wherein the isolation of the power block does not reduce a power capacity of the system due to a use of one or more redundant blocks.

14. The system of claim 8, wherein a DC output is reduced based on the isolation.

15. A method comprising:
detecting, by a controlling chip, a fault in a power block of a power supply; and
isolating, by the controlling chip, the power block, wherein power is allowed to flow through one or more other power blocks.

16. The method of claim 15, wherein isolation devices on the power block are configured to block power flowing through the power block following a command from the controlling chip.

17. The method of claim 15, wherein the power block and the other power blocks may include:
electromagnetic interference (EMI) filter blocks;
Power Factor Correction (PFC) blocks; and
direct current (DC)-DC blocks.

18. The method of claim 17, wherein the blocks include:
a first isolation device before each of the EMI filter blocks and a second isolation device after each of the EMI filter blocks;
a first isolation device before each of the PFC blocks and a second isolation device after each of the PFC blocks; and
a first isolation device before each of the DC-DC blocks and a second isolation device after each of the DC-DC blocks.

19. The method of claim 18, wherein a Field-Effect Transistor (ORing FET) acts as the second isolation device for each of the DC-DC blocks.

20. The method of claim 15, wherein the isolation of the power block does not reduce a power capacity of the power supply due to a use of one or more redundant blocks.
